(19) United States
(12) Patent Application Publication
(10) Pub. No.: US 2025/0051500 A1
(43) Pub. Date: Feb. 13, 2025

(54) RADIATION-CURABLE COMPOSITION

(71) Applicant: Marabu GmbH & Co. KG, Tamm (DE)

(72) Inventors: Jochen Rupp, Tamm (DE); Oliver Boehringer, Winnenden (DE); Thorsten Lifka, Duernten (CH); Tobias Christoph Lang, Waiblingen (DE)

(73) Assignee: Marabu GmbH & Co. KG, Tamm (DE)

(21) Appl. No.: 18/795,681

(22) Filed: Aug. 6, 2024

(30) Foreign Application Priority Data
Aug. 7, 2023 (DE) 10 2023 120915.9

(51) Int. Cl. C08F 220/18; B05D 5/02; C08F 2/44; C08F 2/50; C08L 75/02; C08L 75/04

(52) U.S. Cl. CPC C08F 220/1806; B05D 5/02; C08F 2/44; C08F 2/50; C08L 75/02; C08L 75/04; B05D 2320/00; B05D 2401/31; B05D 2502/005

(57) ABSTRACT

A radiation-curable composition includes at least one monofunctional monomer and/or at least one multifunctional monomer, at least one photoinitiator compound, and at least one matting agent, wherein the at least one matting agent is at least one aminoplast resin. Methods of producing the radiation-curable composition, methods of coating a substrate with the radiation-curable composition, and substrates coated with the radiation-cured composition are also disclosed.

### CROSS-REFERENCE TO RELATED APPLICATIONS

This application claims the benefit of German Patent Application No. DE 102023120915.9, filed Aug. 7, 2023, incorporated herein by reference in its entirety.

### TECHNICAL FIELD

This disclosure relates to a radiation-curable, preferably UV-curable, composition, a method of producing the radiation-curable, preferably UV-curable, composition, a method of coating, especially printing, a substrate, and a substrate coated, especially printed, with the radiation-cured, preferably UV-cured, composition.

### BACKGROUND

Digital printing technology, especially inkjet printing technology, is increasingly being used for industrial printing tasks. Digital printing technology features elevated flexibility compared to analogous methods. Further advantages are the nonexistence of fixed masters, and the possibility of contactlessly decorating differently shaped articles directly, i.e. without use of labels or stickers.

A particular challenge in the direct decoration of all kinds of vessels, especially glass bottles, is to achieve direct decoration with a matted surface.

Conventional compositions often contain what are called matting agents for this purpose. Among the compositions known in this connection are those that contain wax-based and/or silicate-based matting agents. A disadvantage of that approach is that those matting agents are in the form of particles that have an average particle diameter of more than 10 μm.

This generally leads to impairment of the properties of the compositions. For example, those compositions, because of the relatively large particle diameter, are unsuitable for digital printing. This is because the particles do not pass through the printhead nozzles that are typically used in digital printing and therefore block the printhead nozzles. To apply a matting composition, it was therefore necessary to date to switch mainly to a screenprinting process.

It could therefore be helpful to provide a digitally printable and matting composition that avoids disadvantages in connection with conventional matting compositions and is notable for very good printability especially in the performance of digital printing, a corresponding method of producing the composition, a coating method, and a correspondingly coated substrate.

### SUMMARY

Disclosed herein is:

A radiation-curable composition including:
at least one monofunctional monomer and/or at least one multifunctional monomer,
at least one photoinitiator compound, and
at least one matting agent, wherein the at least one matting agent is at least one aminoplast resin.

A method of producing a radiation-curable composition including at least one monofunctional monomer and/or at least one multifunctional monomer, at least one photoinitiator compound, and at least one matting agent, wherein the at least one matting agent is at least one aminoplast resin, including:
a) providing a first matting agent-containing composition and a second matting agent-containing composition,
b) mixing the first matting agent-containing composition and the second matting agent-containing composition,
wherein
the matting agent in the first matting agent-containing composition has an average particle diameter distribution different than the matting agent in the second matting agent-containing composition, and/or
the first matting agent-containing composition is free of a wetting agent, and the second matting agent-containing composition contains a wetting agent.

A method of coating, or printing, a substrate, including:
a) applying, or applying in layers, of a radiation-curable composition including at least one monofunctional monomer and/or at least one multifunctional monomer, at least one photoinitiator compound, and at least one matting agent, wherein the at least one matting agent is at least one aminoplast resin, to a surface of the substrate and
b) curing of the radiation-curable composition applied by action of electromagnetic radiation or UV radiation.

A substrate coated or printed with a radiation-cured or UV-cured composition including at least one monofunctional monomer and/or at least one multifunctional monomer, at least one photoinitiator compound, and at least one matting agent, wherein the at least one matting agent is at least one aminoplast resin.

### DETAILED DESCRIPTION

Our radiation-curable, preferably UV-curable or UV-curing, composition comprises
at least one monofunctional monomer and/or at least one multifunctional monomer,
at least one photoinitiator compound, and
at least one matting agent.

The at least one matting agent is at least one aminoplast resin, preferably at least one urea resin.

The radiation-curable composition is preferably a radiation-curable, preferably UV-curable, matting composition.

The radiation-curable composition is further preferably a radiation-curable, preferably UV-curable, ink composition, especially matting ink composition.

Alternatively, the radiation-curable composition may preferably be a coating composition, especially a paint composition or a clearcoat composition, especially a matting paint composition or a matting clearcoat composition.

In particular, the paint composition or clearcoat composition may comprise spray paints, screenprinting paints, dipcoating paints, rolling paints or pourable paints.

The radiation-curable composition is preferably a radiation-curable composition for coating or printing, especially digital printing, of a substrate and/or substrate surface.

Further preferably, the substrate and/or substrate surface is a material that cannot absorb any liquid, i.e. a non-liquid-absorptive material, especially glass, plastic or metal.

The radiation-cured, preferably UV-cured, composition preferably has a layer thickness of 0.3 mm to 2 mm on the substrate.

The radiation-curable composition is preferably free of any uncurable solvent, especially any uncurable organic solvent, preferably free of alcohols, ketones and/or esters. This has the advantage that emissions resulting from solvent vapor can be kept low and can meet the German maximum workplace concentration (MAK).

The expression “matting composition” means a composition that can be used for coating or printing, especially digital printing, to achieve a matt coating, especially a matt print, on a substrate.

The expression “radiation-curable, preferably UV-curable, composition” means a composition that can be cured under the action of electromagnetic radiation, preferably ultraviolet radiation (UV radiation).

The expression “radiation-curable, preferably UV-curable, ink composition” means an ink composition that can be cured under the action of electromagnetic radiation, preferably ultraviolet radiation (UV radiation).

The expression “radiation-curable, preferably UV-curable, paint composition” means a paint composition that can be cured under the action of electromagnetic radiation, preferably ultraviolet radiation (UV radiation).

The expression “radiation-curable, preferably UV-curable, clearcoat composition” means a clearcoat composition that can be cured under the action of electromagnetic radiation, preferably ultraviolet radiation (UV radiation).

The expression “clearcoat composition” means a paint composition which is transparent, i.e. light-transmissive, in particular transmissive to electromagnetic radiation or electromagnetic waves having a wavelength of 380 nm to 700 nm.

The expression “paint composition” means a coating composition which is applied, preferably thinly, to articles and is built up by chemical and/or physical operations, for example, evaporation of a solvent, to form a film, especially a continuous, solid film.

The expression “ultraviolet radiation (UV radiation)” preferably means radiation within a wavelength range of 100 nm to 450 nm, in particular 100 nm to 420 nm.

The expression “monofunctional monomer” means a monomer having just one functional group per monomer molecule.

The expression “at least one monofunctional monomer” may mean just one monofunctional monomer, i.e. just one type of monofunctional monomer, or a multitude of different monofunctional monomers.

The expression “multifunctional monomer” means a monomer having at least two different functional groups.

The expression “at least one multifunctional monomer” may mean just one multifunctional monomer, i.e. just one type of multifunctional monomer, or a multitude of different multifunctional monomers.

The expression “at least one photoinitiator compound” means one photoinitiator compound, i.e. one type of photoinitiator compound, or a multitude of different photoinitiator compounds, i.e. two or more different photoinitiator compounds. Accordingly, the radiation-curable, preferably UV-curable, composition may include, for example, just one photoinitiator compound, i.e. just one type of photoinitiator compound, or a combination or mixture of different photoinitiator compounds.

The expression “Norrish type I photoinitiator” means a photoinitiator which breaks down into two free radicals under the action of electromagnetic radiation, preferably ultraviolet radiation (UV radiation), usually as a result of what is called a-scission. The free radicals formed can trigger chain polymerization and/or crosslinking with partial or complete curing of the radiation-curable, preferably UV-curable, composition.

The expression “Norrish type II photoinitiator” means a photoinitiator capable of abstracting a hydrogen atom from an adjacent molecule. This can then trigger chain polymerization and/or crosslinking with partial or complete curing of the radiation-curable, preferably UV-curable, composition.

The expression “matting agent” means an additive or a compound, especially for matting compositions, which affects the surface of the composition such that its gloss falls and hence leads to matting. The matting agent preferably brings about controlled roughness of the coating surface, which results in diffuse light scatter, which leads to matting.

The expression “at least one matting agent” may mean just one matting agent, i.e. just one type of matting agent, or a multitude of different matting agents.

The expression “aminoplast resin” means an amino resin or amide resin which is a curable synthetic resin, especially melamine resin, dicyandiamide resin or urea resin, that is obtained by polycondensation of carbonyl compounds, especially formaldehyde, also called methanal, and amine or amide compounds, especially melamine, dicyandiamide or urea.

The expression “at least one aminoplast resin” may mean just one aminoplast resin, i.e. just one type of aminoplast resin, or a multitude of different aminoplast resins.

We surprisingly found that our compositions, because of their at least one matting agent which is different from known compositions, are particularly advantageously printable digitally, especially by an inkjet printing method. This is particularly advantageous for the coating, especially printing, of substrates, for example, bottles and/or drinking glasses and other non-liquid-absorptive surfaces.

A further surprising effect of our compositions is that the use of an aminoplast resin, especially urea resin, as matting agent can establish the desired gloss of the composition in a controlled and simple manner via changes in the concentration of the at least one matting agent, especially without impairment of the viscosity of the composition and hence without risking deterioration of the digital print. This is particularly advantageous to produce a very matt surface of a kind which has not been achievable to date with conventional compositions by digital printing.

On top of that, the at least one matting agent envisaged advantageously has the effect that, for the first time, a digital printing method can produce not only matt, in particular low-reflection, surfaces but also surfaces having specific tactile properties, such as a “soft-touch” surface that seem to feel particularly soft or surfaces having better grip.

Furthermore, our compositions are also advantageous with regard to the intended coating or printing outcome and have the particular feature of high mechanical and chemical stability, especially with respect to polishing, scratches, wet abrasion and/or dry abrasion.

In one configuration, the at least one aminoplast resin is a polymethylurea.

Polymethylurea in particular is of particularly good suitability as matting agent to achieve the advantages of the radiation-curable composition.

The polymethylurea is preferably a urea-methanal polycondensate. Methanal is also known by the name formaldehyde. Further preferably, the polymethylurea is a thermoset.

Further preferably, the polymethylurea can be produced as an amorphous, especially amorphous particulate, structure, which has been found to be particularly advantageous for the matting effect of the composition.

In addition, the polymethylurea may have 0.20% to 0.30%, in particular 0.25%, free hydroxyl groups, which allows crosslinking of the polymethylurea, especially with isocyanates.

The polymethylurea preferably features heat stability of 200° C. to 300° C. and/or a Mohs hardness of 3.0 to 4.0, especially 3.5.

The expression “polymethylurea” means an aminoplast resin prepared by an addition reaction of urea and methanal to give urea methylol, followed by a condensation reaction of urea methylol units. The reaction described in this paragraph can produce a three-dimensional molecular structure that can have an advantageous effect on the amorphous structure of polymethylurea.

In a further configuration, the at least one matting agent, in particular the at least one aminoplast resin, has a proportion of 10% by weight to 60% by weight, especially 15% by weight to 60% by weight, preferably 20% by weight to 50% by weight, especially 25% by weight, based on the total weight of the radiation-curable composition. In particular, the proportions disclosed in this paragraph for the at least one matting agent, especially for the at least one aminoplast resin, have been found to be particularly advantageous from the point of view of matting and printability of the composition.

The proportions of the at least one matting agent that are described in the preceding paragraph have been found to be particularly advantageous for the matting quality of the radiation-curable composition.

In a further configuration, the radiation-curable composition, aside from the at least one aminoplast resin, does not include any further matting agent.

The radiation-curable composition is preferably free of any inorganic matting agent, especially selected from the group consisting of silicates, especially pyrogenic silicates, precipitated silicates, wax-modified silicates, or silane-modified silicates, mineral fillers and combinations of at least two of the aforementioned inorganic matting agents.

Further preferably, the radiation-curable composition, aside from the at least one matting agent, especially the at least one aminoplast resin, is free of any other organic matting agent, especially selected from the group consisting of thermoset polyurethanes, thermoplastic polymers, especially polyacrylates, polyurethanes or polyamides, waxes, especially unmodified polyethylene waxes, modified polyethylene waxes, polypropylene waxes or polyamide waxes, and combinations of at least two of the aforementioned matting agents.

In a further configuration, the radiation-curable composition includes at least one wetting agent.

The expression “at least one wetting agent” may mean just one wetting agent, i.e. just one type of wetting agent, or a multitude of different wetting agents.

The at least one wetting agent is preferably a wetting agent selected from the group consisting of anionic wetting agents, cationic wetting agents, nonionic wetting agents and mixtures of at least two of the aforementioned wetting agents.

Further preferably, the at least one wetting agent is a polyurethane, especially a polyurethane modified with at least one functional group, or a mixture of at least two polyurethanes, especially polyurethane modified with at least one functional group.

The wetting agents mentioned can advantageously act as surface-active substances and, through wetting of the components of the composition, preferably the at least one matting agent, especially the at least one aminoplast resin, further preferably matting agent particles, especially aminoplast resin particles, can prevent the components from sticking together, especially clumping, without adversely affecting, in particular too significantly lowering, the viscosity of the radiation-curable composition.

The at least one wetting agent preferably has a proportion of 0.1% by weight to 10% by weight, especially 0.2% by weight to 7% by weight, preferably 0.5% by weight to 5% by weight, based on the total weight of the composition. In particular, the proportions disclosed in this paragraph for the at least one wetting agent have been found to be particularly advantageous from the point of view of printability of the composition.

In a further configuration, the at least one matting agent, especially the at least one aminoplast resin, is in the form of particles, preferably in the radiation-curable composition.

The matting agent, especially the at least one aminoplast resin, in the form of particles preferably comprises particles including the at least one aminoplast resin, especially polymethylurea, or consisting of the at least one aminoplast resin, especially polymethylurea.

The particles preferably have an average particle diameter≤(less than or equal to) 10 μm, especially of 0.5 μm to 5 μm, preferably of 0.6 μm to 1.3 μm. This is determined, for example, by dynamic or static laser light scattering. In particular, the particle diameters of the at least one matting agent that are disclosed in this paragraph have been found to be particularly advantageous from the point of view of matting and printability of the ink composition. A further advantage of the particle diameters disclosed in this paragraph is that the particles can pass unhindered through the printhead nozzle of a digital printer.

In a further configuration, the at least one matting agent, especially the at least one aminoplast resin, is a mixture of at least two different aminoplast resins.

The different aminoplast resins are preferably polymethylurea.

In a further configuration, the first matting agent and the second matting agent have different average particle diameters.

The at least two different aminoplast resins are preferably polyurea having different average particle diameters. In other words, the at least two aminoplast resins preferably differ, especially exclusively, by a different average particle diameter.

It is preferably the case that 0.5% to 15%, preferably 1% to 10%, especially 1.5%, of one aminoplast resin of the at least two different aminoplast resins has an average particle diameter > (greater than) 1 μm, especially of 1 μm to 10 μm, preferably of 0.5 μm to 5 μm, further preferably of 0.6 μm to 1.3 μm.

Further preferably, 0.5% to 15%, preferably 1% to 10%, especially 1.2%, of one aminoplast resin of the at least two different aminoplast resins has an average particle diameter>1 μm, especially of 1 μm to 10 μm, preferably of 0.5 μm to 5 μm, further preferably of 0.6 μm to 1.3 μm.

Preferably, the particle diameter distribution of the first and second matting agents is D50 0.6 μm, D90 0.8 μm and D99 1.3 μm.

The datum “D50” preferably means a particle diameter distribution in which 50% of all particles are smaller than the diameter specified therefor.

The datum “D90” preferably means a particle diameter distribution in which 90% of all particles are smaller than the diameter specified therefor.

The datum “D99” preferably means a particle diameter distribution in which 99% of all particles are smaller than the diameter specified therefor.

In a further configuration, the at least one monofunctional monomer is selected from the group consisting of acrylate monomer, methacrylate monomer, acrylamide monomer, especially 4-acryloylmorpholine, N-vinylamide monomer, vinyl acrylate monomer and mixtures of at least two of the aforementioned monofunctional monomers.

The at least one monofunctional monomer is preferably an acrylate monomer and/or methacrylate monomer, especially selected from the group consisting of 2-phenoxyethyl acrylate, isobornyl acrylate, n-octyldecyl acrylate, cyclic trimethylolpropane formal acrylate, lauryl acrylate, alkoxylated lauryl acrylate such as ethoxylated lauryl acrylate, isodecyl acrylate, caprolactone acrylate, 3,3,5-trimethylcyclohexyl acrylate, 4-hydroxybutyl acrylate, isooctyl acrylate, 2-(2-ethoxyethoxy)ethyl acrylate, butyl acrylate, benzyl acrylate, 2-(1,1-dimethylethyl)cyclohexyl acrylate, 3-(1, 1-dimethylethyl)cyclohexyl acrylate, 4-(1,1-dimethylethyl)cyclohexyl acrylate, ethoxylated phenyl acrylate, alkoxylated nonylphenol acrylate, o-phenylphenoxyethyl acrylate, phenoxybenzyl acrylate, trimethylcyclohexyl acrylate, tridecyl acrylate, 4-tert-butylcyclohexyl acrylate, behenyl acrylate, stearyl acrylate, isobornyl methacrylate, 4-tert-butylcyclohexyl methacrylate, lauryl methacrylate, isodecyl methacrylate, 2-phenoxyethyl methacrylate, isooctyl methacrylate, benzyl methacrylate, cyclohexyl methacrylate, 3,3,5-trimethylcyclohexyl methacrylate, alkoxylated nonylphenol methacrylate, hydroxyethyl methacrylate, 2-N-morpholinoethyl methacrylate and mixtures of at least two of the aforementioned monofunctional acrylate monomers and/or methacrylate monomers.

Further preferably, the at least one monofunctional monomer is an N-vinylamide monomer or a vinyl acrylate monomer, selected from the group consisting of N-vinylcaprolactam, N-vinylpyrrolidone, vinylmethyloxazolidinone (VMOX), 2-(2-vinyloxyethoxy)ethyl acrylate (VEEA), 2-(2-vinyloxyethoxy)ethyl methacrylate and mixtures of at least two of the aforementioned monomers.

The at least one monofunctional monomer preferably has a proportion of 1% by weight to 40% by weight, especially 2% by weight to 35% by weight, preferably 5% by weight to 30% by weight, more preferably 5% by weight to 20% by weight, based on the total weight of the radiation-curable, preferably UV-curable, composition.

The proportions described in the preceding paragraph have been found to be particularly advantageous for the adhesion of the radiation-curable composition on a substrate. In particular, the proportion described in the preceding paragraph for the at least one monofunctional monomer can achieve a low network density of the radiation-curable composition which has been found to be particularly advantageous for adhesion to non-absorptive substrates.

In a further configuration, the at least one multifunctional monomer is selected from the group consisting of acrylate monomer, especially diacrylate monomer, methacrylate monomer, acrylamide monomer, especially 4-acryloylmorpholine, N-vinylamide monomer, vinyl acrylate monomer and mixtures of at least two of the aforementioned monofunctional monomers.

The at least one multifunctional monomer is preferably an acrylate monomer and/or methacrylate monomer, especially selected from the group consisting of (octahydro-4,7-methano-1H-indenediyl)bis(methylene) diacrylate, tricyclodecanedimethanol diacrylate, butanediol diacrylate, 1,2-ethylene glycol diacrylate, dodecanol 1,12-diacrylate, decanediol 1,10-diacrylate, esterdiol diacrylate, propoxylated 2-neopentyl glycol diacrylate, tris(2-hydroxyethyl) isocyanurate triacrylate, propoxylated neopentyl glycol diacrylate, hexanediol diacrylate, tripropylene glycol diacrylate, tetracthylene glycol diacrylate, dipropylene glycol diacrylate, alkoxylated hexanediol diacrylate, 3-methylpentane-1,5-diol diacrylate, alkoxylated cyclohexanedimethanol diacrylate, tricyclodecanedimethanol diacrylate, trimethylolpropane triacrylate, alkoxylated trimethylolpropane triacrylate, ethoxylated trimethylolpropane triacrylate, glycerol propoxylate triacrylate, pentaerythritol triacrylate, dipentaerythritol pentaacrylate, dipentaerythritol hexaacrylate, ethoxylated pentaerythritol tetraacrylate, pentaerythritol tetraacrylate, ditrimethylolpropane tetraacrylate, polyethylene glycol diacrylates, 1,2-ethylene glycol dimethacrylate, dodecanol 1,12-dimethacrylate, tris-(2-hydroxyethyl) isocyanurate trimethacrylate, hexanediol dimethacrylate, ethoxylated bisphenol A dimethacrylate, trimethylolpropane trimethacrylate, pentaerythritol tetramethacrylate and mixtures of at least two of the aforementioned multifunctional acrylate monomers and/or methacrylate monomers.

The at least one multifunctional monomer preferably has a proportion of 10% by weight to 60% by weight, especially 15% by weight to 55% by weight, preferably 20% by weight to 50% by weight, based on the total weight of the radiation-curable, preferably UV-curable, composition.

In a further configuration, the at least one photoinitiator is a Norrish type I photoinitiator or a Norrish type II photoinitiator or a mixture of Norrish type I and/or Norrish type II photoinitiators.

The at least one photoinitiator is preferably selected from the group consisting of monomeric benzophenone derivatives, polymeric benzophenone derivatives, benzyl ketones, monomeric hydroxy ketones, polymeric hydroxy ketones, α-amino ketones, phosphine oxide derivatives, acylphosphine oxides, metallocenes, benzoin ethers, benzil ketals, α-hydroxyalkylphenones, α-aminoalkylphenones, monomeric thioxanthone derivatives, polymeric thioxanthone derivatives, isopropylthioxanthenones, arylsulfonium salts, aryliodoninium salts, oxime derivatives, imidazole derivatives and mixtures of at least two of the photoinitiators mentioned.

Further preferably, the at least one photoinitiator is selected from the group consisting of ethyl 2,4,6-trimethylbenzoyl phenylphosphinate, isobutyl dibenzoylphosphine oxide, diphenyl (2,4,6-trimethylbenzoyl)phosphine oxide, 1-methyl-(2,6-dimethoxybenzoyl)phenyl-phosphine oxide, methyl isobutyrylmethylphosphinate, isopropyl pivaloylphenylphosphinate, methyl p-toluoylphenylphosphinate, methyl o-toluoylphenylphosphinate, isopropyl p-tert-butylbenzoylphenylphosphinate, methyl acryloylphenylphosphinate, o-toluoylphenylphosphine oxide, vinyl pivaloylphenylphosphinate, methyl pivaloylphenylphosphinate, isopropyl pivaloylphenylphosphinate, bis(2,6-dichlorobenzoyl)phenylphosphine oxide, bis(2,6-dichlorobenzoyl)-2,5-dimethylphenylphosphine oxide, bis(2,6-dichlorobenzoyl)-4-ethoxyphenylphosphine oxide, bis(2,6-dichlorobenzoyl)-4-propylphenylphosphine oxide, bis(2,6-dichlorobenzoyl)-2-naphthylphosphine oxide, bis(2,6-dichlorobenzoyl)-1-naphthylphosphine oxide, bis(2,6-dichlorobenzoyl)-4-chlorophenylphosphine oxide, bis(2,6-dichlorobenzoyl)-2,4-dimethoxyphenylphosphine oxide, bis(2,6-dichlorobenzoyl)ethylphosphine oxide, bis(2,6-dichlorobenzoyl)-4-octylphenylphosphine oxide, bis(2,4,6-trimethylbenzoyl)phenylphosphine oxide, bis(2,4,6-trimethylbenzoyl)-2,5-dimethylphenylphosphine oxide, bis(2,6-dichloro-3,4,5-trimethoxybenzoyl)-2,5-dimethylphenylphosphine oxide, bis(2,6-dichloro-3,4,5-trimethoxybenzoyl)-4-ethoxyphenylphosphine oxide, bis(2-methyl-1-naphthyl)-2,5-dimethylphenylphosphine oxide, bis(2-methyl-1-naphthyl)-4-ethoxyphenylphosphine oxide, bis(2-methyl-1-naphthyl)-2-naphthylphosphine oxide, bis(2-methyl-1-naphthyl)-4-propylphenylphosphine oxide, bis (2-methyl-1-naphthyl)-2,5-trimethylphenylphosphine oxide, bis(2-methoxy-1-naphthyl)-4-ethoxyphenylphosphine oxide, bis(2-chloro-1-naphthyl)-2,5-dimethylphenylphosphine oxide, bis(2,6-dimethoxybenzoyl)-2,4,6-trimethylpentylphosphine oxide and mixtures of at least two of the aforementioned photoinitiators.

Further preferably, the at least one photoinitiator has a proportion of 1% by weight to 20% by weight, especially 2% by weight to 25% by weight, preferably 3% by weight to 15% by weight, based on the total weight of the radiation-curable, preferably UV-curable, composition.

In a further configuration, the radiation-curable composition has a viscosity at 40° C. and a shear rate of 2000 s⁻¹ of 3 mPas to 150 mPas, especially 4 mPas to 140 mPas, preferably 5 mPas to 120 mPas.

Advantageously, the at least one matting agent, especially the at least one aminoplast resin, by comparison with conventional matting agents, has a comparatively minor effect on the viscosity and rheology properties of the composition. By comparison with conventional matting agents, this makes it possible to use a comparatively high proportion by weight in the radiation-curable composition without adversely affecting the viscosity and rheology properties of the composition.

The expression “viscosity” preferably means a shear viscosity. This means the resistance of the composition to shear. Viscosity is preferably measured with a viscometer, especially in accordance with EN ISO 3219. In particular, viscosity can be measured with the aid of a rheometer, for example, an “MCR 302” rheometer (manufacturer: Anton Paar), at 40° C. at a shear rate of 2000 s⁻¹.

In a further configuration, the radiation-curable composition has a gloss ≤ (less than or equal to) 60 GU, especially of < (less than) 55 GU to <50 GU, preferably <45 GU to <40 GU. The glosses measured in this paragraph were preferably measured at 60° C. in a glossmeter.

The expression “gloss” preferably means a measure of the extent to which an incident light beam is reflected by the radiation-curable composition, in particular the composition that has been applied to a substrate and cured. Gloss is preferably measured with a glossmeter, also called reflectometer. This can be used to measure gloss in the unit of measurement of GU (gloss units). Specifically, the term “gloss” is defined as the ratio between the incident light and the light reflected by the surface at the respectively chosen angle of mirror reflection. In other words, gloss defines the mattness of the composition, in particular the composition that has been applied to a substrate and cured.

In a further configuration, the radiation-curable composition also includes at least one additive selected from the group consisting of stabilizer, binder, dispersing additive, filler, levelling additive and mixtures of at least two of the additives mentioned.

The radiation-curable composition preferably has a proportion of additives of 0.1% by weight to 15% by weight, especially 0.5% by weight to 10% by weight, preferably 1% by weight to 10% by weight, based on the total weight of the radiation-curable composition.

The expression “stabilizer” means an additive that binds free radicals in a composition to avoid unintentional initiation of polymerization.

The stabilizer is preferably a polymer, preferably a copolymer, more preferably a block copolymer. In addition, the stabilizer may be dissolved in dicarboxylic ester. More preferably, the stabilizer may be a stabilizer known by the Genorad 20 trade name. The radiation-curable composition may have a proportion of the stabilizer of 0.1% by weight to 10% by weight, especially 0.5% by weight to 5% by weight, preferably 0.5% by weight to 2% by weight, based on the total weight of the radiation-curable composition.

The expression “binder” means an additive that has rheology-modifying properties and particularly advantageously has the effect that disadvantageous formation of sediment in the radiation-curable composition can be avoided.

The binder is preferably a urethane compound, preferably a urethane acrylate, more preferably an aliphatic urethane acrylate, especially preferably an aliphatic urethane diacrylate. The radiation-curable composition may have a proportion of the binder of 0.1% by weight to 10% by weight, especially 1% by weight to 8% by weight, preferably 3% by weight to 7% by weight, based on the total weight of the radiation-curable composition.

The expression “dispersing additive” means an additive intended to stabilize components of the composition, preferably the at least one matting agent, especially the at least one aminoplast resin, further preferably matting agent particles, especially aminoplast resin particles, of the radiation-curable composition via steric hindrance. The dispersing additive preferably creates an electrical charge of the components, and the resulting repulsion effect and steric stabilization prevent occurrence of possible co-flocculation.

The dispersing additive is preferably a polyurethane, preferably a polyurethane modified with at least one functional group or a mixture of at least two polyurethanes, especially polyurethane modified with at least one functional group. More preferably, the dispersing additive may be a dispersing additive known by the Disperbyk-168 trade name. The radiation-curable composition may have a proportion of the dispersing additive of 0.1% by weight to 10% by weight, especially 1% by weight to 6% by weight, preferably 1% by weight to 3% by weight, based on the total weight of the radiation-curable composition.

The expression “levelling additive” means an additive intended to level out unevenness on a surface.

We also provide a method of producing a radiation-curable, preferably UV-curable, composition, especially our compositions, comprising:
a) providing a first matting agent-containing composition and a second matting agent-containing composition,
b) mixing the first matting agent-containing composition and the second matting agent-containing composition, wherein
   the matting agent in the first matting agent-containing composition has an average particle diameter distribution different than the matting agent in the second matting agent-containing composition, and/or
   the first matting agent-containing composition is free of a wetting agent, and the second matting agent-containing composition contains a wetting agent.

The first matting agent-containing composition and the second matting agent-containing composition may preferably also include at least one mutually identical or different monofunctional monomer and/or multifunctional monomer.

The method may also comprise a step c) of adding a binder, especially a urethane compound, preferably a urethane acrylate, further preferably an aliphatic urethane acrylate, especially preferably an aliphatic urethane diacrylate, to be able to advantageously avoid disadvantageous formation of sediment.

The first matting agent-containing composition and the second matting agent-containing composition are preferably an aminoplast resin-containing, especially polymethylurea-containing, composition.

The first matting agent-containing composition preferably does not include any wetting agent.

Further preferably, the second matting agent-containing composition includes a wetting agent; in particular, the matting agent in the second matting agent-containing composition has been dispersed with a wetting agent.

The first matting agent-containing composition and the second matting agent-containing composition preferably include particles including at least one aminoplast resin, especially polymethylurea, or consisting of at least one aminoplast resin, especially polymethylurea.

It is preferably the case that 0.5% to 3%, preferably 1% to 2%, especially 1.5%, of the particles of the first matting agent-containing composition have an average particle diameter>1 μm, especially of 1 μm to 10 μm, preferably of 0.5 μm to 5 μm, further preferably of 0.6 μm to 1.3 μm.

It is further preferably the case that 0.5% to 3%, preferably 1% to 3%, especially 1.2%, of the particles of the second matting agent-containing composition have an average particle diameter >1 μm, especially of 1 μm to 10 μm, preferably of 0.5 μm to 5 μm, further preferably of 0.6 μm to 1.3 μm.

The distribution of the particle diameters of the first and second matting agents is preferably D50 0.6 μm, D90 0.8 μm and D99 1.3 μm.

The datum “D50” means a particle diameter distribution in which 50% of all particles are smaller than the diameter specified therefor.

The datum “D90” means a particle diameter distribution in which 90% of all particles are smaller than the diameter specified therefor.

The datum “D99” means a particle diameter distribution in which 99% of all particles are smaller than the diameter specified therefor.

The use of two matting agent-containing compositions in which the first matting agent-containing composition is free of any wetting agent and the second matting agent-containing composition contains a wetting agent led to the surprising outcome that the wetting agent prevents clumping of the matting agent particles in the radiation-curable composition without lowering the viscosity of the radiation-curable composition.

With regard to further features and advantages of the method, for avoidance of repetition, reference is made completely to the remarks made within the scope of our compositions. The features and advantages that are described there particularly with regard to the radiation-curable, preferably UV-curable, composition are also applicable mutatis mutandis to the method.

We further provide a method of coating, especially printing, a substrate and/or a substrate surface, especially a glass and/or a glass surface, comprising:
a) applying, especially applying in layers, of a radiation-curable composition, especially our compositions, to a surface of the substrate, and
b) curing of the radiation-curable composition applied, especially applied in layers, by the action of electromagnetic radiation, especially UV radiation.

In addition, the method may include a step c) of heating the radiation-curable composition that has been applied and cured. The heating is effected at a temperature of 150° C. for 5 min. Step c) has the advantageous effect that incompletely converted monomer can be converted and/or evaporated off.

The radiation-curable, preferably UV-curable, composition can in principle be applied to the surface of the substrate merely selectively or partially, i.e. only in regions or sections, or completely, i.e. over the full area or continuously.

The coating, especially printing, of a substrate and/or a substrate surface, especially a glass and/or a glass surface, is preferably a printing operation on a three-dimensional body, i.e. coating, especially printing, of curved surfaces, especially of vessels, bottles, closures, glasses, cups, other hollow bodies or other non-liquid-absorptive substrates.

In the performance of step a), it is possible to apply only one layer or a multitude of layers of the radiation-curable, preferably UV-curable, composition to the surface of the substrate.

Moreover, step a) and/or step b) may be performed repeatedly, especially once to 25 times, preferably 4 times to 15 times.

The applying of just one layer may also be referred to as single-pass printing. The applying of a multitude of layers, especially more than one layer, may also be referred to as multipass printing.

In the case of multilayer application of the radiation-curable, preferably UV-curable, composition to the surface of the substrate, the radiation-curable, preferably UV-curable, composition can be cured after applying each individual layer or after complete application, i.e. after application of all layers, of the radiation-curable, preferably UV-curable, composition to the surface of the substrate.

Moreover, for performance of step b), it is possible to use a mercury vapor lamp or a UV light-emitting diode (UV-LED). With the aid of the mercury vapor lamp, UV radiation is preferably generated within a wavelength of 200 nm to 450 nm. With the aid of the UV light-emitting diode, preference is given to generating UV radiation within a wavelength of 360 nm to 450 nm.

Moreover, individual layers of the radiation-curable, preferably UV-curable, composition applied may be incompletely cured, especially by the UV light-emitting diode, and the individual layers may instead be initially merely UV-pinned. UV pinning involves applying a dose of ultraviolet (UV) light with low intensity to a UV-curable composition. The result is that the UV-curing composition changes to a state of higher viscosity but does not completely cure. This is also referred to as “gelating”.

Moreover, step b) may be followed by conclusive curing by the action of UV radiation. This can be effected by a UV light-emitting diode having high radiation intensity and/or a mercury vapor lamp.

The radiation-curable, preferably UV-curable, composition is preferably applied to the surface of the substrate in a digital printing method, especially inkjet printing method.

The expression “digital printing method” means a printing method in which the printed image is transferred directly from a computer to a printing machine without use of a static or fixed printing plate.

The expression “inkjet printing method” means a method in which small droplets of liquid ink are generated and applied to a substrate. It is first possible here to create a continuous inkjet (CIJ), and secondly to discontinuously create individual droplets that are created merely on demand and applied to the substrate (drop on demand, DOD).

Moreover, prior to the applying of the radiation-curable, preferably UV-curable, composition, a primer composition or underprint varnish composition may be applied in layers, especially in the form of one or more layers, to at least part of the surface of the substrate, and then the radiation-curable, preferably UV-curable, composition may be applied in the form of one or more layers to the primer or underprint varnish composition applied to the surface of the substrate. It is possible here in principle for the primer or underprint varnish composition likewise to be applied to the surface of the substrate only selectively or partially, i.e. only in sections or regions, or completely, i.e. over the full area or continuously. The primer or underprint varnish composition may be a radiation-curable, preferably UV-curable, or solvent-based primer or underprint varnish composition. In particular, the primer composition may be a UV-curing primer composition as described in EP 3 453 687 A1. The disclosure-content of EP '687 in relation to the UV-curing primer composition described therein is incorporated herein by explicit reference.

Moreover, the substrate, preferably for alteration of its surface properties, may be pretreated prior to the application of the radiation-curable, preferably UV-curable, composition and/or prior to the application of the radiation-curable, preferably UV-curable, primer composition. For example, the substrate may be pretreated by flaming and/or flame-pyrolytic coating, especially silicatization.

With regard to further features and advantages of the method, for avoidance of repetition, reference is made completely to the remarks made within the above description. The features and advantages that are described therein, especially in relation to the radiation-curable, preferably UV-curable, composition, are also applicable mutatis mutandis to the method.

We still further provide a substrate coated, especially printed, with our radiation-cured, preferably UV-cured, composition.

The substrate has preferably been at least partly coated, especially printed, with our radiation-cured, preferably UV-cured, composition.

Further preferably, the substrate is a material incapable of absorbing liquid, i.e. a non-liquid-absorptive material, especially glass, plastic or metal.

The substrate may preferably be a substrate having a curved surface, especially vessels, bottles, closures, glasses, drinking glasses, cups or other hollow bodies.

With regard to further features and advantages of the substrate, especially the radiation-cured, preferably UV-cured, composition, for avoidance of repetition, reference is likewise made completely to the description so far, especially to the remarks made in the scope of our compositions. The features and advantages that are elucidated therein, especially in relation to the radiation-curable, preferably UV-curable, composition are also applicable mutatis mutandis to the substrate.

### EXAMPLES

Further advantages and aspects of this disclosure will be apparent from the claims and from the description of working examples that are elucidated hereinafter by the examples.

### Example 1

### Radiation-Curable Composition:

| | |
|---|---|
| Monofunctional monomer: | 3,3,5-trimethylcyclohexyl acrylate: 42% |
| Aminoplast resin: | polymethylurea (1.5% with an average |
| | particle diameter >1 μm): 30% |
| Aminoplast resin-containing | mixture containing polymethylurea (1.2% |
| mixture: | with an average particle diameter >1 μm) |
| | and polyurethane as wetting agent: 10% |
| Dispersing additive: | Disperbyk-168: 2% |
| Binder: | aliphatic urethane diacrylate: 6% |
| Stabilizer: | Genorad 20: 1% |
| Photoinitiator: | ethyl (2,4,6-trimethylbenzoyl)- |
| | phenylphosphinate (TPO-L): 9% |
| Result: | |

The composition achieved a gloss at 60° of <40 GU, especially 40 GU.

### Example 2

### Radiation-Curable Composition:

| | |
|---|---|
| Monofunctional monomer: | 3,3,5-trimethylcyclohexyl acrylate: 24% |
| Aminoplast resin: | polymethylurea (1.5% with an average |
| | particle diameter >1 μm): 60% |
| Dispersing additive: | Disperbyk-168: 2% |
| Binder: | aliphatic urethane diacrylate: 4% |
| Stabilizer: | Genorad 20: 1% |
| Photoinitiator: | ethyl (2,4,6-trimethylbenzoyl)- |
| | phenylphosphinate (TPO-L): 9% |
| Result: | |

The composition achieved a gloss at 60° of <70 GU, especially 70 GU.

### Example 3

### Radiation-Curable Composition:

| | |
|---|---|
| Monofunctional monomer: | 3,3,5-trimethylcyclohexyl acrylate: 44% |
| Aminoplast resin-containing | mixture containing polymethylurea (1.2% |
| mixture: | with an average particle diameter >1 μm) |
| | and a polyurethane as wetting agent: 40% |
| Dispersing additive: | Disperbyk-168: 2% |
| Binder: | aliphatic urethane diacrylate: 4% |
| Stabilizer: | Genorad 20: 1% |
| Photoinitiator: | ethyl (2,4,6-trimethylbenzoyl)- |
| | phenylphosphinate (TPO-L): 9% |
| Result: | |

The composition achieved a gloss at 60° of <100 GU, especially 100 GU.

This disclosure discloses at least the following:

Clause 1. A radiation-curable, preferably UV-curable, composition comprising at least one monofunctional monomer and/or at least one multifunctional monomer, at least one photoinitiator compound and at least one matting agent, characterized in that the at least one matting agent is at least one aminoplast resin.

Clause 2. The radiation-curable composition according to clause 1, characterized in that the at least one aminoplast resin is a polymethylurea.

Clause 3. The radiation-curable composition according to Clause 1 or 2, characterized in that the at least one matting agent has a proportion of 10% by weight to 60% by weight, in particular 15% by weight to 60% by weight, preferably 20% by weight to 50% by weight, based on the total weight of the composition.

Clause 4. The radiation-curable composition according to any of the preceding clauses, characterized in that the radiation-curable composition, aside from the at least one aminoplast resin, does not include any further matting agent.

Clause 5. The radiation-curable composition according to any of the preceding clauses, characterized in that the radiation-curable composition includes at least one wetting agent, especially a polyurethane or mixtures of at least two polyurethanes.

Clause 6. The radiation-curable composition according to any of the preceding clauses, characterized in that the at least one matting agent is in the form of particles, especially having an average particle diameter of ≤ 10 μm, especially of 0.5 μm to 5 μm, preferably of 0.6 μm to 1.3 μm.

Clause 7. The Radiation-curable composition according to any of the preceding clauses, characterized in that the at least one matting agent is a mixture of at least two different aminoplast resins.

Clause 8. The Radiation-curable composition according to Clause 7, characterized in that the at least two different aminoplast resins have different average particle diameters.

Clause 9. The Radiation-curable composition according to any of the preceding clauses, characterized in that the at least one monofunctional monomer is an acrylate monomer and/or methacrylate monomer, especially selected from the group consisting of 2-phenoxyethyl acrylate, isobornyl acrylate, n-octyldecyl acrylate, cyclic trimethylolpropane formal acrylate, lauryl acrylate, alkoxylated lauryl acrylate such as ethoxylated lauryl acrylate, isodecyl acrylate, caprolactone acrylate, 3,3,5-trimethylcyclohexyl acrylate, 4-hydroxybutyl acrylate, isooctyl acrylate, 2-(2-ethoxyethoxy)ethyl acrylate, butyl acrylate, benzyl acrylate, 2-(1,1-dimethylethyl)cyclohexyl acrylate, 3-(1, 1-dimethylethyl)cyclohexyl acrylate, 4-(1,1-dimethylethyl)cyclohexyl acrylate, ethoxylated phenyl acrylate, alkoxylated nonylphenol acrylate, o-phenylphenoxyethyl acrylate, phenoxybenzyl acrylate, trimethylcyclohexyl acrylate, tridecyl acrylate, 4-tert-butylcyclohexyl acrylate, behenyl acrylate, stearyl acrylate, isobornyl methacrylate, 4-tert-butylcyclohexyl methacrylate, lauryl methacrylate, isodecyl methacrylate, 2-phenoxyethyl methacrylate, isooctyl methacrylate, benzyl methacrylate, cyclohexyl methacrylate, 3,3,5-trimethylcyclohexyl methacrylate, alkoxylated nonylphenol methacrylate, hydroxyethyl methacrylate, 2-N-morpholinoethyl methacrylate and mixtures of at least two of the aforementioned monofunctional acrylate monomers and/or methacrylate monomers.

Clause 10. The Radiation-curable composition according to any of the preceding clauses, characterized in that the at least one multifunctional monomer is an acrylate monomer and/or methacrylate monomer, especially selected from the group consisting of (octahydro-4,7-methano-1H-indenediyl) bis(methylene) diacrylate, tricyclodecanedimethanol diacrylate, butanediol diacrylate, 1,2-ethylene glycol diacrylate, dodecanol 1,12-diacrylate, decanediol 1,10-diacrylate, esterdiol diacrylate, propoxylated 2-neopentyl glycol diacrylate, tris(2-hydroxyethyl) isocyanurate triacrylate, propoxylated neopentyl glycol diacrylate, hexanediol diacrylate, tripropylene glycol diacrylate, tetraethylene glycol diacrylate, dipropylene glycol diacrylate, alkoxylated hexanediol diacrylate, 3-methylpentane-1,5-diol diacrylate, alkoxylated cyclohexanedimethanol diacrylate, tricyclodecanedimethanol diacrylate, trimethylolpropane triacrylate, alkoxylated trimethylolpropane triacrylate, ethoxylated trimethylolpropane triacrylate, glycerol propoxylate triacrylate, pentaerythritol triacrylate, dipentaerythritol pentaacrylate, dipentaerythritol hexaacrylate, ethoxylated pentacrythritol tetraacrylate, pentaerythritol tetraacrylate, ditrimethylolpropane tetraacrylate, polyethylene glycol diacrylates, 1,2-ethylene glycol dimethacrylate, dodecanol 1,12-dimethacrylate, tris-(2-hydroxyethyl) isocyanurate trimethacrylate, hexanediol dimethacrylate, ethoxylated bisphenol A dimethacrylate, trimethylolpropane trimethacrylate, pentaerythritol tetramethacrylate and mixtures of at least two of the aforementioned multifunctional acrylate monomers and/or methacrylate monomers.

Clause 11. The Radiation-curable composition according to any of the preceding clauses, characterized in that the at least one photoinitiator is selected from the group consisting of ethyl 2,4,6-trimethylbenzoyl phenylphosphinate, isobutyl dibenzoylphosphine oxide, diphenyl(2,4,6-trimethylbenzoyl)phosphine oxide, 1-methyl-(2,6-dimethoxybenzoyl)phenylphosphine oxide, methyl isobutyrylmethylphosphinate, isopropyl pivaloylphenylphosphinate, methyl p-toluoylphenylphosphinate, methyl 0-toluoylphenylphosphinate, isopropyl p-tert-butylbenzoylphenylphosphinate, methyl acryloylphenylphosphinate, o-toluoylphenylphosphine oxide, vinyl pivaloylphenylphosphinate, methyl pivaloylphenylphosphinate, isopropyl pivaloylphenylphosphinate, bis(2,6-dichlorobenzoyl)phenylphosphine oxide, bis(2,6-dichlorobenzoyl)-2,5-dimethylphenylphosphine oxide, bis(2,6-dichlorobenzoyl)-4-ethoxyphenylphosphine oxide, bis(2,6-dichlorobenzoyl)-4-propylphenylphosphine oxide, bis(2,6-dichlorobenzoyl)-2-naphthylphosphine oxide, bis(2,6-dichlorobenzoyl)-1-naphthylphosphine oxide, bis(2,6-dichlorobenzoyl)-4-chlorophenylphosphine oxide, bis(2,6-dichlorobenzoyl)-2,4-dimethoxyphenylphosphine oxide, bis(2,6-dichlorobenzoyl)ethylphosphine oxide, bis(2,6-dichlorobenzoyl)-4-octylphenylphosphine oxide, bis(2,4,6-trimethylbenzoyl)phenylphosphine oxide, bis(2,4,6-trimethylbenzoyl)-2,5-bis(2,6-dichloro-3,4,5-trimethoxybenzoyl)-2,5-dimethylphenylphosphine oxide, dimethylphenylphosphine oxide, bis (2,6-dichloro-3,4,5-trimethoxybenzoyl)-4-ethoxyphenylphosphine oxide, bis(2-methyl-1-naphthyl)-2,5-dimethylphenylphosphine oxide, bis(2-methyl-1-naphthyl)-4-ethoxyphenylphosphine oxide, bis(2-methyl-1-naphthyl)-2-naphthylphosphine oxide, bis(2-methyl-1-naphthyl)-4-propylphenylphosphine oxide, bis(2-methyl-1-naphthyl)-2,5-trimethylphenylphosphine oxide, bis(2-methoxy-1-naphthyl)-4-ethoxyphenylphosphine oxide, bis(2-chloro-1-naphthyl)-2,5-dimethylphenylphosphine oxide, bis(2,6-dimethoxybenzoyl)-2,4,6-trimethylpentylphosphine oxide and mixtures of at least two of the aforementioned photoinitiators.

Clause 12. The radiation-curable composition according to any of the preceding clauses, characterized in that the radiation-curable composition has a viscosity at 40° C. and a shear rate of 2000 s−1 of 3 mPas to 50 mPas, especially 4 mPas to 40 mPas, preferably 5 mPas to 20 mPas.

Clause 13. The radiation-curable composition according to any of the preceding clauses, characterized in that the radiation-curable composition has a gloss≤60 GU, especially of 55 GU to 5 GU, preferably of 40 GU to 15 GU.

Clause 14. A method of producing a radiation-curable, preferably UV-curable, composition according to any of the preceding clauses, having the following steps: a) providing a first matting agent-containing composition and a second matting agent-containing composition, b) mixing the first matting agent-containing composition and the second matting agent-containing composition, characterized in that the matting agent in the first matting agent-containing composition has an average particle diameter distribution different than the matting agent in the second matting agent-containing composition, and/or the first matting agent-containing composition is free of a wetting agent, and the second matting agent-containing composition contains a wetting agent.

Clause 15. A method of coating, especially printing, a substrate, having the following steps: (c) applying, especially applying in layers, of a radiation-curable composition according to any of Clauses 1 to 14 to a surface of the substrate and (d) curing of the radiation-curable composition applied, especially applied in layers, by the action of electromagnetic radiation, especially UV radiation.

Clause 16. A method of coating according to Clause 15, characterized in that, in the performance of step a), the radiation-curable, preferably UV-curable, composition is applied to the surface of the substrate in a digital printing method, especially inkjet printing method.

Clause 17. A substrate coated, especially printed, with a radiation-cured, preferably UV-cured, composition according to any of Clauses 1 to 13.

Preferred configurations are defined in the dependent claims and in the description. The wording of all claims is hereby explicitly incorporated into this description by reference.

What is claimed is:

1. A radiation-curable composition comprising:
at least one monofunctional monomer and/or at least one multifunctional monomer,
at least one photoinitiator compound, and
at least one matting agent, wherein the at least one matting agent is at least one aminoplast resin.

2. The radiation-curable composition according to claim 1, wherein the at least one aminoplast resin is a polymethylurea.

3. The radiation-curable composition according to claim 1, wherein the at least one matting agent has a proportion of 10% by weight to 60% by weight, based on a total weight of the composition.

4. The radiation-curable composition according to claim 1, wherein the radiation-curable composition, aside from the at least one aminoplast resin, does not include any further matting agent.

5. The radiation-curable composition according to claim 1, wherein the radiation-curable composition includes at least one wetting agent, or a polyurethane or mixtures of at least two polyurethanes.

6. The radiation-curable composition according to claim 1, wherein the at least one matting agent is in the form of particles having an average particle diameter of≤10 μm.

7. The radiation-curable composition according to claim 1, wherein the at least one matting agent is a mixture of at least two different aminoplast resins.

8. The radiation-curable composition according to claim 7, wherein the at least two different aminoplast resins have different average particle diameters.

9. The radiation-curable composition according to claim 1, wherein the at least one monofunctional monomer is an acrylate monomer and/or methacrylate monomer, selected from the group consisting of 2-phenoxyethyl acrylate, isobornyl acrylate, n-octyldecyl acrylate, cyclic trimethylolpropane formal acrylate, lauryl acrylate, alkoxylated lauryl acrylate such as ethoxylated lauryl acrylate, isodecyl acrylate, caprolactone acrylate, 3,3,5-trimethylcyclohexyl acrylate, 4-hydroxybutyl acrylate, isooctyl acrylate, 2-(2-ethoxyethoxy)ethyl acrylate, butyl acrylate, benzyl acrylate, 2-(1,1-dimethylethyl) cyclohexyl acrylate, 3-(1,1-dimethylethyl)cyclohexyl acrylate, 4-(1,1-dimethylethyl) cyclohexyl acrylate, ethoxylated phenyl acrylate, alkoxylated nonylphenol acrylate, o-phenylphenoxyethyl acrylate, phenoxybenzyl acrylate, trimethylcyclohexyl acrylate, tridecyl acrylate, 4-tert-butylcyclohexyl acrylate, behenyl acrylate, stearyl acrylate, isobornyl methacrylate, 4-tert-butylcyclohexyl methacrylate, lauryl methacrylate, isodecyl methacrylate, 2-phenoxyethyl methacrylate, isooctyl methacrylate, benzyl methacrylate, cyclohexyl methacrylate, 3,3,5-trimethylcyclohexyl methacrylate, alkoxylated nonylphenol methacrylate, hydroxyethyl methacrylate, 2-N-morpholinoethyl methacrylate and mixtures of at least two of the aforementioned monofunctional acrylate monomers and/or methacrylate monomers.

10. The radiation-curable composition according to claim 1, wherein the at least one multifunctional monomer is an acrylate monomer and/or methacrylate monomer, selected from the group consisting of (octahydro-4,7-methano-1H-indenediyl) bis(methylene) diacrylate, tricyclodecanedimethanol diacrylate, butanediol diacrylate, 1,2-ethylene glycol diacrylate, dodecanol 1,12-diacrylate, decanediol 1,10-diacrylate, esterdiol diacrylate, propoxylated 2-neopentyl glycol diacrylate, tris(2-hydroxyethyl) isocyanurate triacrylate, propoxylated neopentyl glycol diacrylate, hexanediol diacrylate, tripropylene glycol diacrylate, tetracthylene glycol diacrylate, dipropylene glycol diacrylate, alkoxylated hexanediol diacrylate, 3-methylpentane-1,5-diol diacrylate, alkoxylated cyclohexanedimethanol diacrylate, tricyclodecanedimethanol diacrylate, trimethylolpropane triacrylate, alkoxylated trimethylolpropane triacrylate, ethoxylated trimethylolpropane triacrylate, glycerol propoxylate triacrylate, pentaerythritol triacrylate, dipentaerythritol pentaacrylate, dipentaerythritol hexaacrylate, ethoxylated pentaerythritol tetraacrylate, pentaerythritol tetraacrylate, ditrimethylolpropane tetraacrylate, polyethylene glycol diacrylates, 1,2-ethylene glycol dimethacrylate, dodecanol 1,12-dimethacrylate, tris-(2-hydroxyethyl) isocyanurate trimethacrylate, hexanediol dimethacrylate, ethoxylated bisphenol A dimethacrylate, trimethylolpropane trimethacrylate, pentaerythritol tetramethacrylate and mixtures of at least two of the aforementioned multifunctional acrylate monomers and/or methacrylate monomers.

11. The radiation-curable composition according to claim 1, wherein the at least one photoinitiator is selected from the group consisting of ethyl 2,4,6-trimethylbenzoyl phenylphosphinate, isobutyl dibenzoylphosphine oxide, diphenyl (2,4,6-trimethylbenzoyl)phosphine oxide, 1-methyl-(2,6-dimethoxybenzoyl) phenylphosphine oxide, methyl isobutyrylmethylphosphinate, isopropyl pivaloylphenylphosphinate, methyl p-toluoylphenylphosphinate, methyl o-toluoylphenylphosphinate, isopropyl p-tert-butylbenzoylphenylphosphinate, methyl acryloylphenylphosphinate, o-toluoylphenylphosphine oxide, vinyl pivaloylphenylphosphinate, methyl pivaloylphenylphosphinate, isopropyl pivaloylphenylphosphinate, bis(2,6-dichlorobenzoyl)phenylphosphine oxide, bis(2,6-dichlorobenzoyl)-2,5-dimethylphenylphosphine oxide, bis(2,6-dichlorobenzoyl)-4-ethoxyphenylphosphine oxide, bis (2,6-dichlorobenzoyl)-4-propylphenylphosphine oxide, bis(2,6-dichlorobenzoyl)-2-naphthylphosphine oxide, bis(2,6-dichlorobenzoyl)-1-naphthylphosphine oxide, bis (2,6-dichlorobenzoyl)-4-chlorophenylphosphine oxide, bis(2,6-dichlorobenzoyl)-2,4-dimethoxyphenylphosphine oxide, bis (2,6-dichlorobenzoyl) ethylphosphine oxide, bis(2,6-dichlorobenzoyl)-4-octylphenylphosphine oxide, bis(2,4,6-trimethylbenzoyl)phenylphosphine oxide, bis (2,4,6-trimethylbenzoyl)-2,5-dimethylphenylphosphine oxide, bis(2,6-dichloro-3,4,5-trimethoxybenzoyl)-2,5-dimethylphenylphosphine oxide, bis(2,6-dichloro-3,4,5-trimethoxybenzoyl)-4-ethoxyphenylphosphine oxide, bis(2-methyl-1-naphthyl)-2,5-dimethylphenylphosphine oxide, bis (2-methyl-1-naphthyl)-4-ethoxyphenylphosphine oxide, bis(2-methyl-1-naphthyl)-2-naphthylphosphine oxide, bis(2-methyl-1-naphthyl)-4-propylphenylphosphine oxide, bis (2-methyl-1-naphthyl)-2,5-trimethylphenylphosphine oxide, bis(2-methoxy-1-naphthyl)-4-ethoxyphenylphosphine oxide, bis(2-chloro-1-naphthyl)-2,5-dimethylphenylphosphine oxide, bis(2,6-dimethoxybenzoyl)-2,4,6-trimethylpentylphosphine oxide and mixtures of at least two of the aforementioned photoinitiators.

12. The radiation-curable composition according to claim 1, wherein the radiation-curable composition has a viscosity at 40° C. and a shear rate of 2000 s⁻¹ of 3 mPas to 50 mPas.

13. The radiation-curable composition according to claim 1, wherein the radiation-curable composition has a gloss≤60 GU.

14. A method of producing a radiation-curable composition according claim 1, comprising:
a) providing a first matting agent-containing composition and a second matting agent-containing composition,
b) mixing the first matting agent-containing composition and the second matting agent-containing composition,
wherein
the matting agent in the first matting agent-containing composition has an average particle diameter distribution different than the matting agent in the second matting agent-containing composition, and/or
the first matting agent-containing composition is free of a wetting agent, and the second matting agent-containing composition contains a wetting agent.

15. A method of coating, or printing, a substrate, comprising:
a) applying, or applying in layers, of a radiation-curable composition according to claim 1 to a surface of the substrate and
b) curing of the radiation-curable composition applied by action of electromagnetic radiation or UV radiation.

16. The method according to claim 15, wherein, in performing step a), the radiation-curable composition is applied to the surface of the substrate in a digital printing method, or inkjet printing method.

17. A substrate coated or printed with a radiation-cured or UV-cured composition according to claim 1.
